(19) United States
(12) Patent Application Publication
(10) Pub. No.: US 2017/0083956 A1
(43) Pub. Date: Mar. 23, 2017

(54) Menu and Menu Item Management System

(71) Applicants: Juli Norris, Spokane, WA (US); Jonathan Sweatt, Spokane, WA (US)

(72) Inventors: Juli Norris, Spokane, WA (US); Jonathan Sweatt, Spokane, WA (US)

(21) Appl. No.: 15/273,415

(22) Filed: Sep. 22, 2016

Related U.S. Application Data
(60) Provisional application No. 62/222,344, filed on Sep. 23, 2015.

(51) Int. Cl. G06Q 30/02; G06F 3/0482

(52) U.S. Cl. CPC G06Q 30/0283; G06F 3/0482

(57) ABSTRACT

Menu and menu item management system and techniques are described. In one implementation, Cost data is collected that describes costs of consumable items. User inputs are received that specify selection of representations of consumable items in a user interface for inclusion as part of a menu item. Inputs are received that specify a menu price for the menu item. A menu item cost is determined for the menu item based at least in part on the cost data and the user inputs and an item cost percentage based on the menu price and the menu item cost. The menu item cost and the item cost percentage are then displayed in the user interface.

### RELATED APPLICATIONS

This Application claims priority under 35 U.S.C. Section 119(e) to U.S. Provisional Patent Application No. 62/222,344, filed Sep. 23, 2015, and titled “Example System and Device,” the entire disclosure of which is hereby incorporated by reference.

### BACKGROUND

Business establishments such as restaurants and bars involved in the sales of consumables (e.g., food and drink) experience the highest failure rates of any type of business entity. This is often due to the failure of an owner to have detailed insight into the actual operations of the establishment.

This lack of detailed insight most typically involves a relationship of a cost of menu items to a price charged for those items, as well as how this may relate to other items on a menu, whether it be food or drink. Consequently, such a lack of understanding may cause conventional business establishments to include menu items that actually result in a loss of money, remove profitable items, as well as lack an understanding of a relationship between different menu items together on overall profitability of the establishment.

### SUMMARY

Menu and menu item management system and techniques are described. In one implementation, cost data is collected that describes costs of consumable items. User inputs are received that specify selection of representations of consumable items in a user interface for inclusion as part of a menu item. Inputs are received that specify a menu price for the menu item. A menu item cost is determined for the menu item based at least in part on the cost data and the user inputs and an item cost percentage based on the menu price and the menu item cost. The menu item cost and the item cost percentage are then displayed in the user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ menu item techniques described herein.

FIG. 2 depicts a system in an example implementation usable to cost engineer a menu item.

FIG. 3 is a flow diagram depicting a procedure in an example implementation in which a menu item is cost engineered.

FIGS. 4-5 depicts example user interfaces exposed by a system of FIG. 2 as part of cost engineering.

FIG. 6 depicts a system in an example implementation usable to cost engineer a plurality of menu items through integration of point-of-sale data.

FIG. 7 is a flow diagram depicting a procedure in an example implementation in which a menu item is cost engineered.

FIGS. 8-13 depicts example user interfaces exposed by the system of FIG. 6 that leverage point-of-sale integration.

FIG. 14 depicts a system in an example implementation in which waste data is generated to track waste, which may be used to increase efficiency of cost engineering performed by a menu item engineering module of FIG. 1.

FIG. 15 depicts an example user interface as outputting indications of total dollar amount and percentages of waste of food.

FIGS. 16 and 17 depicts example user interfaces for beverages in which waste is illustrated as breakage.

FIG. 18 includes a user interface showing a division between front labor costs (e.g., wait staff, bartenders, hosts) and kitchen labor costs.

FIG. 19 depicts a user interface in which costs by day or shown for labor as it pertains to sales for a respective time period.

FIG. 20 depicts a user interface usable as part of scheduling, which may be based on these labor costs and percentage of sales.

FIG. 21 illustrates an example system including various components of an example device that can be implemented as any type of computing device as described and/or utilize with reference to FIGS. 1-20 to implement embodiments of the techniques described herein.

### DETAILED DESCRIPTION

### Overview

Business establishments that are involved in the sale of consumables such as food and beverages are prone to failure. This is often due to a lack of understanding of the “business side” of the establishment, rather than a lack of understanding of customers and desires of those customers. For example, a business establishment may provide a menu that is desired by a wide range of customers, even to the point that those customers are forced to wait in order to frequent the establishment. However, a lack of understanding of profitability and desirability of different menu items may cause a manger of the business to make erroneous decisions which effect profitability of the establishment, and may even result in eventual failure.

Accordingly, a menu and menu item management system is described. In one example, one or more computing devices are configured to support cost engineering of menu items. To do so, cost data is obtained that describes costs of consumable items that are used as part of a menu item. This cost data may be entered manually by a user through interaction with a user interface, or obtained in real time automatically and without user intervention via a network by the computing device itself, such as from a consumables supply service.

User inputs are then received involving selection of representations of consumable items via a user interface. A user, for instance, may interact with the user interface to select representations of a burger patty, bun, onions, and lettuce to form a menu item of a burger. Cost of these individual consumable items is then used to arrive at a menu item cost for the menu item. Additional items sold along with the menu item (e.g., French fries) may also be added as part of the menu item cost, i.e., which may also be considered a plate cost.

From the menu item cost (e.g., for the menu item which may or may not include the additional items), an item cost percentage is determined through comparison with a menu price. In this way, a manager of a business is provided with a readily understood metric regarding cost and profitability of particular menu items, as well as can compare different items with each other. This may also be aggregated into menu categories (e.g., sandwiches, appetizers, deserts, cold plates, hot plates, salads, and so forth) and even for the menu as a whole. In at least one example, the cost data is updated in real time such that the manager may also track profitability and cost in light of ever changing conditions as typically encountered in restaurant and bar businesses. The restaurant management system may also be configured to incorporate other costs, such as labor and facilities costs.

Further, this may be incorporated with other functionality as part of a restaurant management system in order to provide even greater insight into the operations of the business. For example, inventory may be captured as part of the system. This may be used as a basis for ordering, suggestions for consumable items to include as a special, and tracking of waste. The tracking of waste of particular consumable items, for instance, may be used to automatically update the cost data to increase accuracy in the costs determined for particular menu items as part of the menu item engineering.

This may also include integration with a point-of-sale device, e.g., an electronic cash register. A point-of-sale device, for instance, may provide data regarding which items are sold, a cost of those items, and which items are sold together. This may be used to track total revenue, total cost, profit margin, and item cost percentages. Knowledge of which items are sold together may also be used by a manager to keep an otherwise unprofitable item such as chicken wings due to an association with purchases of a profitable items, such as beverages. Additionally, this may be performed in real time for output in a user interface such that the manager may readily determine “what is happening now” (e.g., over the course of a business day), which is not possible using conventional techniques.

This may also include integration with a social media module. Social media, for instance, may be used to track a rating and review. The manager may then use this information as part of planning of menu items (e.g., to keep popular items and related items), staffing, and so forth. This may also include collection of demographics, which may be correlated with POS information (e.g., which users purchased which items) to help to form recommendations that target particular demographics, e.g., market particular menu items to particular people. This may be done by correlating user names with public profiles, opt-ins as part of a dedicated application that permits collection of this data, and so forth. Further discussion of these and other examples is included in the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

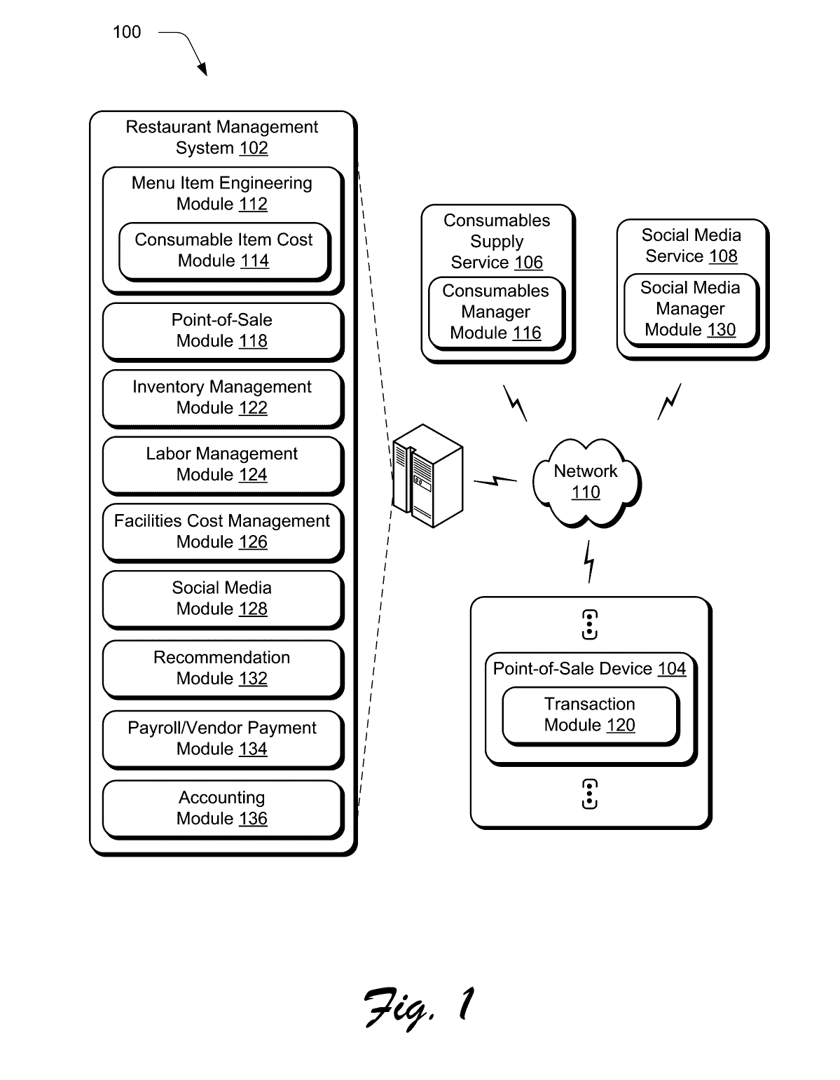

FIG. 1 is an illustration of an environment 100 in an example implementation that is operable to employ techniques described herein. The illustrated environment 100 includes a restaurant manager system 102, a point-of-sale device 104, consumables supply service 106, and social media service 108, each of which are implemented by one or more computing devices. Computing devices may be configured in a variety of ways.

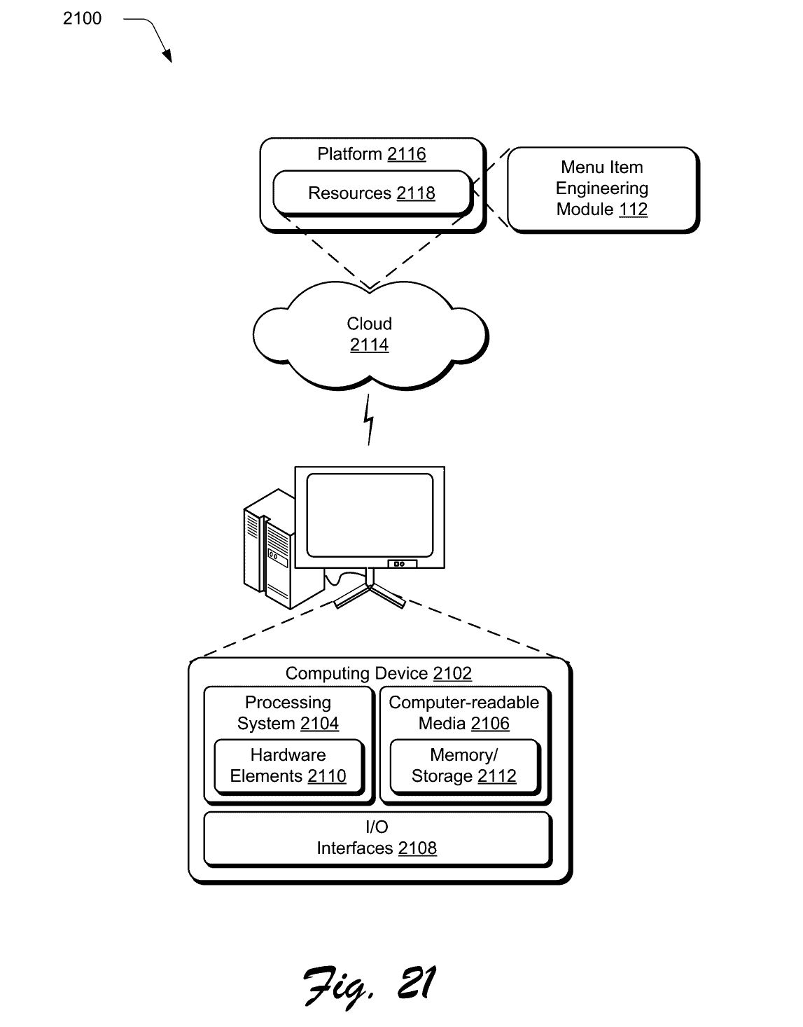

A computing device, for instance, may be configured as a desktop computer, a laptop computer, a mobile device (e.g., assuming a handheld configuration such as a tablet or mobile phone as illustrated), and so forth. Thus, a computing device may range from full resource devices with substantial memory and processor resources (e.g., personal computers, game consoles) to a low-resource device with limited memory and/or processing resources (e.g., mobile devices). Additionally, the computing device may be representative of a plurality of different devices, such as multiple servers utilized by a business to perform operations “over the cloud” as further described in relation to FIG. 21.

The restaurant management system 102 is illustrated as including a menu item engineering module 112, which is implemented at least partially in hardware of a computing device. The menu item engineering module 112 is representative of functionality to cost engineer menu items for inclusion on a menu, i.e., a collection of menu items available for purchase.

The menu item engineering module 112, for instance, may leverage a consumable item cost module 114. The consumable item cost module 114 is implemented at least partially in hardware to obtain cost data that describes costs of a business entity associated with the restaurant management system 102 to obtain consumable items. Consumable items, for instance, may include food, drink, or disposable items used as part of preparation or consumption of food or drink, e.g., food wrap, napkins, and so forth.

The consumable item cost module 114 may obtain this cost data from a variety of sources. In one example, the cost data is entered manually by a user through interaction with a user interface output by the consumable item cost module 114. In another example, the cost data is obtained automatically and without user intervention by the consumable item cost module 114. The consumable item cost module 114, for instance, may communicate with a consumable manager module 116 over the network 110, via one or more networks calls, application programming interfaces, web services, and so forth. The consumable manager module 116 is representative of functionality to maintain cost data of consumable items that are available physically via an associated consumables supply service 106. This cost data may be exposed in real time for collection by the consumable item cost module 114 such that the cost data leveraged as part of the menu item engineering module 112 is the most accurate available.

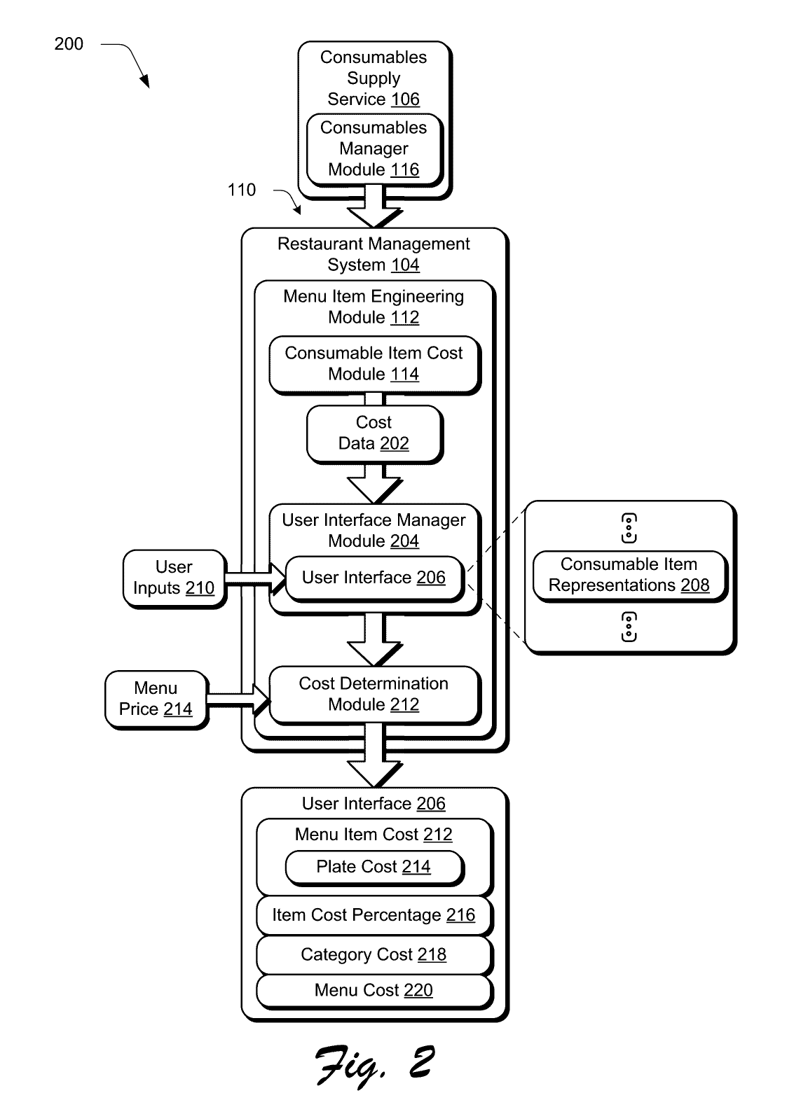

The menu item engineer module 112 then uses this information to cost engineer menu items. To do so, a user interface is exposed by the menu item engineering module 112 via which a user selects representations of consumable items that are used as part of a menu item. A cost of these items is then used by the menu item engineering module 112 to arrive at a menu item cost (e.g., cost of the menu item itself), plate cost (e.g., cost of the menu items and sides), item cost percentage (e.g., percentage of menu item or plate cost to menu price), category cost (e.g., cost of menu items within a particular category, can be expressed as a percentage), and even a menu cost. In this way, a manager may readily determine a cost of menu items, make potential changes to menu items, and use this as a basis to manage which menu items are included on a menu. Further discussion of this and other examples is described in the following in relation to FIGS. 2-5.

The restaurant management system 102 is also illustrated as including a point-of sale module 118. The point-of-sale module 118 is implemented at least partially in hardware of a computing device to integrate with a point-of-sale device 104. The point-of-sale device 104, for instance, may be configured as a computing device having functionality to collect payment from customers of an establishment associated with the restaurant management system 102. This may include collection of cash and credit card information by a transaction module 120. The transaction module 120 may also track which menu items are purchased, a time at which those items are purchased, who those items were purchased by, and so forth. Data collected by the transaction module 120 is communicated via the network 110 to the point-of-sale module 118. This data may be leveraged in a variety of ways, such as to determine total revenue, total cost, profit margin, and menu item cost for each of the plurality of menu items. This may also be used to determine “which users purchased what” (e.g., demographics) and in which combinations these items are purchased. From this, along with the menu engineering, a manager may readily determine which items are profitable and even which items, even though not profitable themselves, lead to profitability due to purchase with other menu items, e.g., chicken wings and beverages.

An inventory management module 122 is also incorporated as part of the restaurant management system 102. The inventory management module 122 is configured to maintain a current state of inventory of consumable items by an establishment associated with the restaurant management system 102. The inventory, for instance, may be manually entered, based on purchases made from a consumables supply service 106, data involving sales as tracked by the point-of-sale device 104, and so forth. In this way, a current state of affairs may be exposed to a manager as to availability of consumable items, which may be used for ordering of additional items via the network 110 from the consumables manager module 116. This may also be used to track waste, such as based on purchases from the consumables supply service 106 in relation to which items are sold, and amounts of menu items sold, and use of consumable items as part of these menu items. This tracking of waste may thus be used as part of menu item engineering to reflect actual usage of consumable items to support different menu items.

The restaurant management system 102 may also be configured to track other costs involved as part of an establishment in providing menu items. A first example of this is illustrated as labor management module 124. The labor management module 124 is representative of functionality implemented via a computing device to address labor costs. This may include scheduling such that a correlation may be made between cost of labor and number of menu items sold. This may also include costs of labor as affecting profitability of the establishment. Likewise, a facilities cost management module 126 may be used to address costs of a facility of the business establishment, such as rent or mortgage payments, parking, upkeep, utilities, and so forth. This may be incorporated generally across the menu items as a determination of profitability.

The restaurant management system 102 also include a social media module 128. Through this module, implemented at least partially in hardware of a computing device, a manager may track reviews and commentary about the establishment. For example, the social media module 128 may communicate via the network 110 with a social media manager module 130 of a social media service 108. The social media manager module 130 may expose posts, ranking, rating, commentary, and other information posted to a social media site, such as Facebook®, Twitter®, Yelp®, Zagats®, Instagram®, and so forth. This may be performed based on tagging, parsing of posts for keywords, and so forth. From this information, a manager using the restaurant management system 102 may quickly address these posts by responding to the posts, make changes (e.g., up staffing at particular times), make decisions about popular menu items, and so forth.

A recommendation module 132 is also incorporated as part of the restaurant management system 102. The recommendation module 132 is implemented at least partially in hardware to generate recommendations. These recommendations may pertain to which menu items to include as part of a menu, which demographics to target using particular menu items, and so forth. In one example, machine learning (e.g., neural networks, deep convolutional neural networks, decision trees, and so forth) are used to analyze a correlation between menu items to determine profitability of these correlations.

Continuing with the previous example, a correlation may be made between particular menu items that are commonly purchased together. This may be exposed by the recommendation module 132 using machine learning (e.g., a latent factor matrix) to arrive at different combinations of menu items that may be of interest. In this way, these combinations may be addressed together in terms of profitability, thereby providing addition insight into operation of the business. This may also be extended to correlate to user demographics. A user, for instance, may opt in as part of use of an application associated with the business to collect demographic data, use through collection of credit information and user name (e.g., correlated with a social media service 108), and so forth. In another example, a user may download an application that permits scheduling, exposure of items on the menu, as well as permits collection of demographic information through parts of the terms and conditions. This data may then be used to correlate demographics with purchases of particular menu items, and may also be used to drive marketing towards these demographics, e.g., particular menu item deals to particular users having identified demographics.

A payroll/vendor payment module 134 is also illustrated as included as part of the restaurant management system 102. This module is representative of functionality implemented at least partially in hardware of a computing device to support payment of payroll and vendors. This may be implemented locally by the computing device and/or integrated with remote systems, e.g., “in the cloud.” Payroll and vendor payments 134, for instance, may be incorporated as part of the menu item engineering module 112 to increase accuracy in cost engineering menu items, e.g., both theoretical and actual based on actual sales. The restaurant management system 102 also includes an accounting module 136 that may be implemented locally or integrated with remote system to provide accounting functionality as part of the restaurant management system 102.

Each of these modules may be made available (e.g., for purchase from an application store) separately to consumers. Thus, the consumer may select and obtain desired functionality which may be leveraged to provide different insights into operation of the establishment. These and other examples are described in the following.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Menu Item Engineering

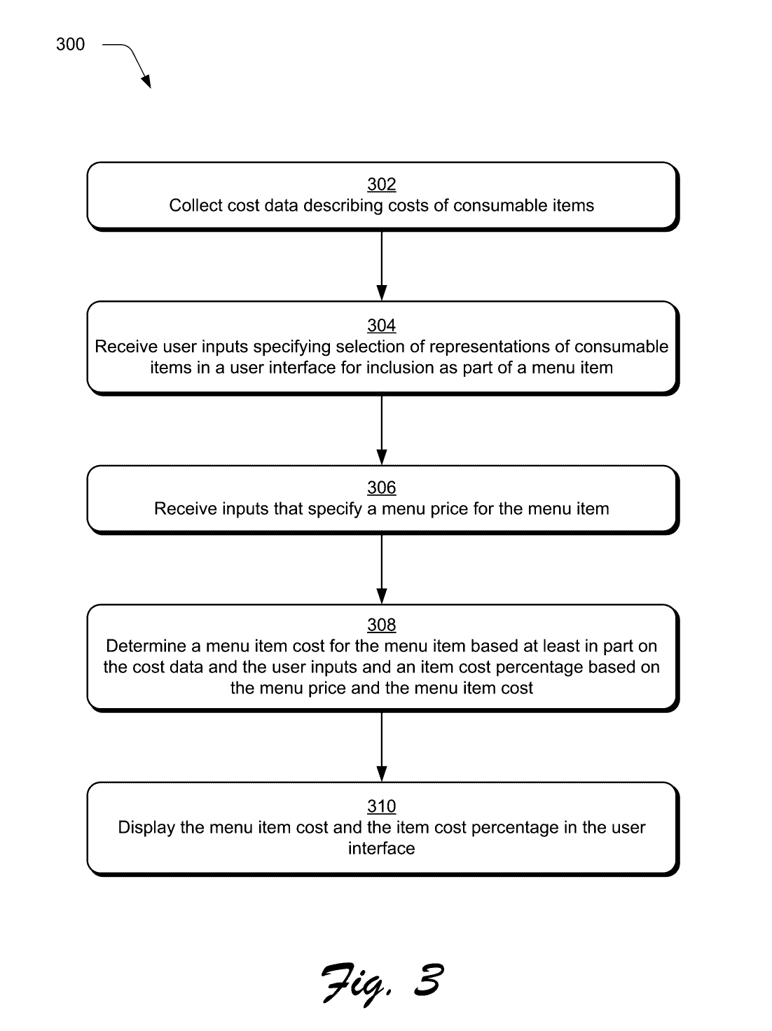

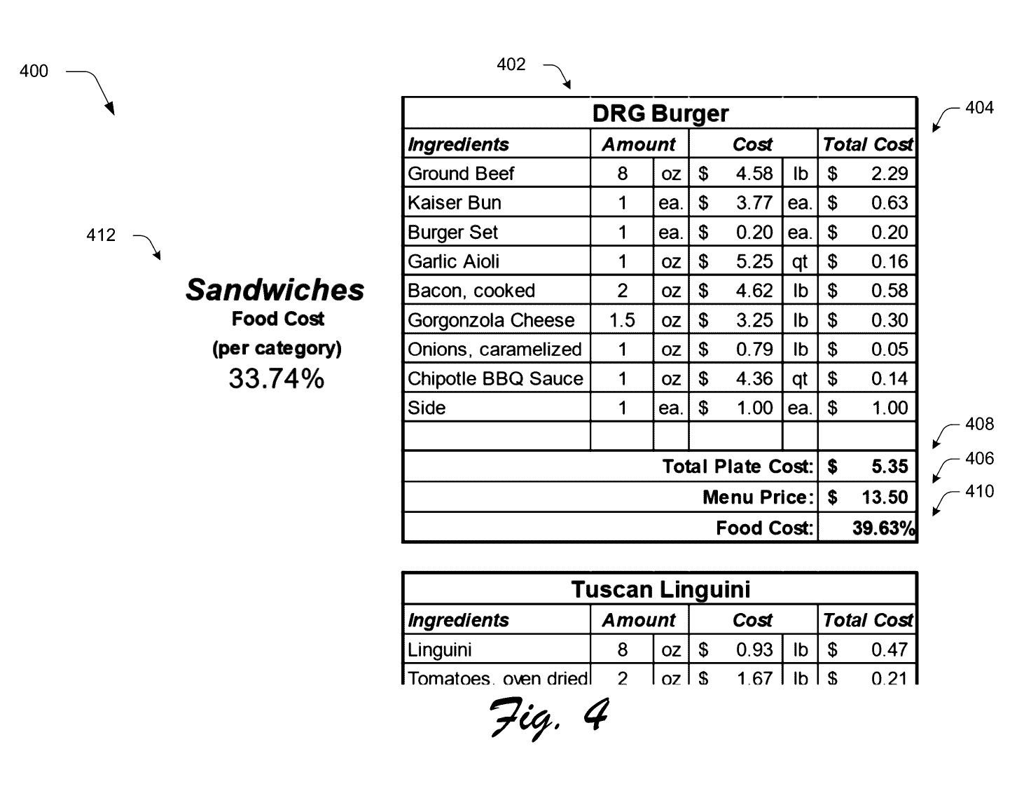

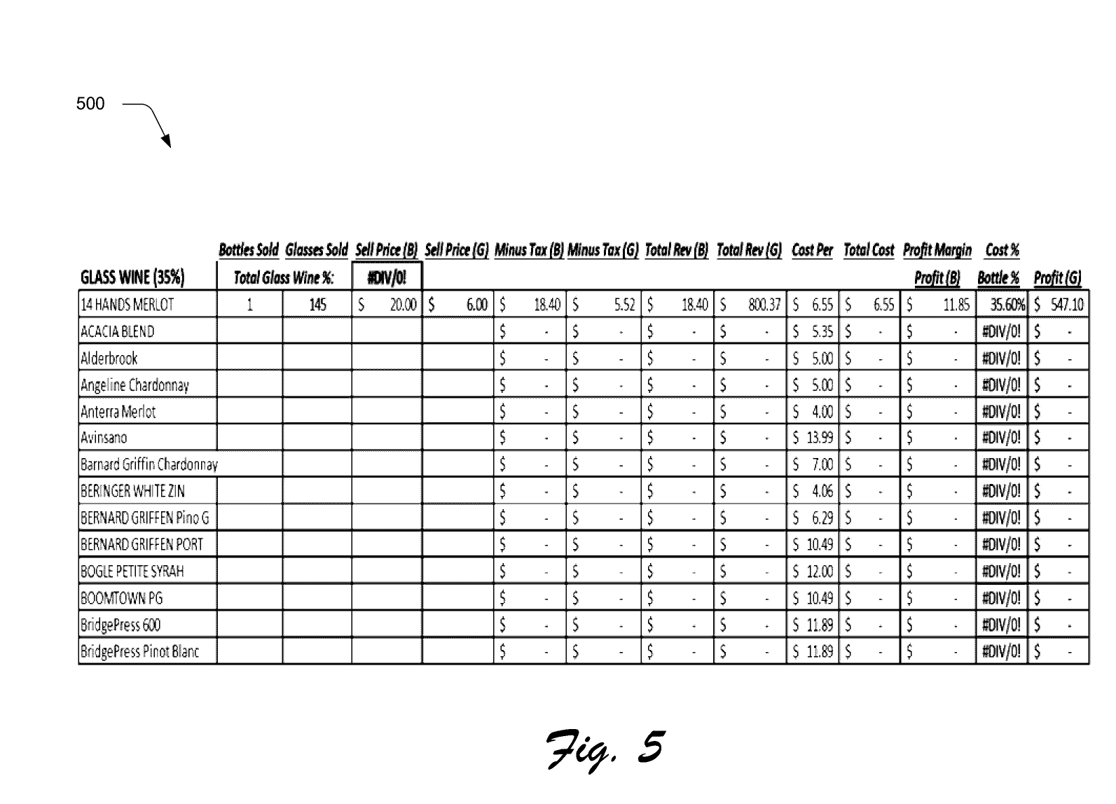

FIG. 2 depicts a system 200 in an example implementation usable to cost engineer a menu item. FIG. 3 depicts a procedure 300 in an example implementation in which a menu item is cost engineered. FIGS. 4-5 depicts example user interfaces 400, 500 exposed by the system 200 of FIG. 2 as part of cost engineering.

The following discussion describes menu engineering techniques that may be implemented utilizing the previously described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made interchangeably to FIGS. 2-5.

Cost data is collected describing costs of consumable items (block 302). In the illustrated example of FIG. 2, for instance, the menu item engineering module 112 includes a consumable item cost module 114. The consumable item cost module 114 is representative of functionality to receive cost data describing costs of consumable items used as part of menu items. Consumable items may include food, drink, and disposable items utilized as part of the menu item, e.g., swizzle sticks, toothpicks, napkins, and so forth.

The consumable item cost module 114 may collect this cost data 202 in a variety of ways. In a first example, a user interacts with a user interface output by the module to manually input a cost of these items, such as from a cost sheet, e.g., by typing, optical character recognition from a digital image captured of a cost sheet, and so forth. In a second example, the consumable item cost module 114 obtains this cost data 202 automatically and without user intervention via a network 110 from a consumables supply service 106. The consumables supply service 106, for instance, may be configured as a web service that exposes the cost data 202. The cost data may then be captured by the module (e.g., via one or more APIs) to arrive at the illustrated cost data 202. In one instance, this may also be performed in real time as cost of consumable items fluctuate. For example, the consumables manager module 116 may communicate alerts and notifications regarding changes to costs of consumable items, which are captured by consumable item cost module 114 through subscription to the service. A variety of other examples are also contemplated.

User inputs are received that specify selection of representations of consumable items in a user interface for inclusion as part of a menu item (block 304). This is illustrated in FIG. 2 through use of a user interface manager module 204. The user interface manager module 204 is implemented at least partially in hardware of a computing device to output a user interface 206 having consumable item representations 208. The consumable item representations 208 are selectable by a user through interaction with the user interface 206 to provide user inputs 210 to select consumable items that are to be used in creation of a menu item.

As shown in the user interface 400 of FIG. 4, for instance, a menu item 402 of “DRG Burger” is being cost engineered to arrive at a theoretical cost. To do so, a user selects representations 404 of consumable items that are used to form the menu item, e.g., ground beef, Kaiser bun, burger set, garlic aioli, bacon, cheese, onions, BBQ sauce. In this case, the menu item cost is a plate cost and thus also include selection of a consumable item as a “side,” e.g., fries, chips, etc. The representations are automatically configured to include amounts as commonly used by the business establishment in making these items. These amounts, for instance, may be set as defaults that may be subsequently modified by a user.

Inputs are also received that specify a menu price for the menu item (block 306). For example, a cost determination module 212 may be used to capture a menu prices 214 to be used to sell the menu item that is being cost engineered. A menu price 406, for instance, may be manually entered and stored by a computing device that implements the system through use of the cost determination module 212. In another instance, the menu price 214 is automatically provided by a point-of-sale module 118 through interaction with a point-of-sale device 104. For example, the menu price 406 may fluctuate due to special offers and thus the menu price 406 captured by the point-of-sale module 118 may reflect these fluctuations and therefore provide increased accuracy.

A menu item cost is determined for the menu item based at least in part on the cost data and the user inputs and an item cost percentage based on the menu price and the menu item cost (block 308). This may be a theoretical cost based on expected costs of consumable items, waste, and so forth. This may also be implemented as an “engineered” actual cost based on actual sales, e.g., through integration with the point-of-sale device 104.

Continuing with the previous example, the menu item cost 408 in this example is a plate cost in that it also addressees a cost of accompanying consumable items (e.g., “sides”). The cost determination module 212, for instance, may use selection and quantities of consumable item representations and convert these quantities and costs based on the cost data 202 to arrive at a cost to include each of these consumable items individually as part of the menu item. In the example user interface 400 of FIG. 4, these costs are exposed as part of the user interface 400 such that a user may readily determine a contribution of individual consumable items on a cost of a menu item and change accordingly, if desired.

The menu item cost and the item cost percentage are then displayed in the user interface (block 310), e.g., theoretical or actual “engineered” cost. The user interface 216, for instance, may include a menu item cost 212 (which may be the cost of the menu item alone or an overall plate cost 214), an item cost percentage 216, a category cost 218, and even an overall menu cost 220. Returning again to FIG. 4, the plate cost 408 is illustrated as a monetary amount of consumable items used to form the menu item 402. This is displayed along with the menu price 406. The item cost percentage 216 is displayed as a “food cost” 410 in the user interface 400, and thus provides an efficient and readily understood way for a user to determine an effect of cost of consumable items on profitability of a respective menu item 402.

This may also be performed for categories of menu items. For example, the menu item 402 may be assigned as part of a category of a menu, the illustrated example of which is “sandwiches” but other examples are also contemplated, such as breakfast, lunch, dinner, appetizers, deserts, hot plates, cold plates, menu item style (e.g., associated nationality), and so forth. Costs associated with individual menu items may then be aggregated within categories based on this assignment, such as to arrive at overall menu item costs 212, plate costs, item cost percentages 216 and so on as category costs 218. In this way, a user is also provided insight into how a particular menu item “fits in” with other similar menu items within a category. This may also be further aggregated “upwards” in a similar manner for menu costs 220 for a menu as a whole.

As shown in FIG. 4, for instance, the food cost 410 (i.e., item cost percentage 216) of the DRG burger 402 menu item is higher than an average food cost 412 of a respective category “sandwiches.” Thus, a manager of the establishment may take this into account, such as to raise a menu price 406, leave as the same as this is a popular item, and so forth. Although a menu item of food was described in this example, this may also be used to cost engineer beverages (e.g., drink composed of a plurality of consumable items) as well as menu items composed of single consumable items, an example of which is shown in the user interface 500 of FIG. 5.

Point-of-Sale Integration

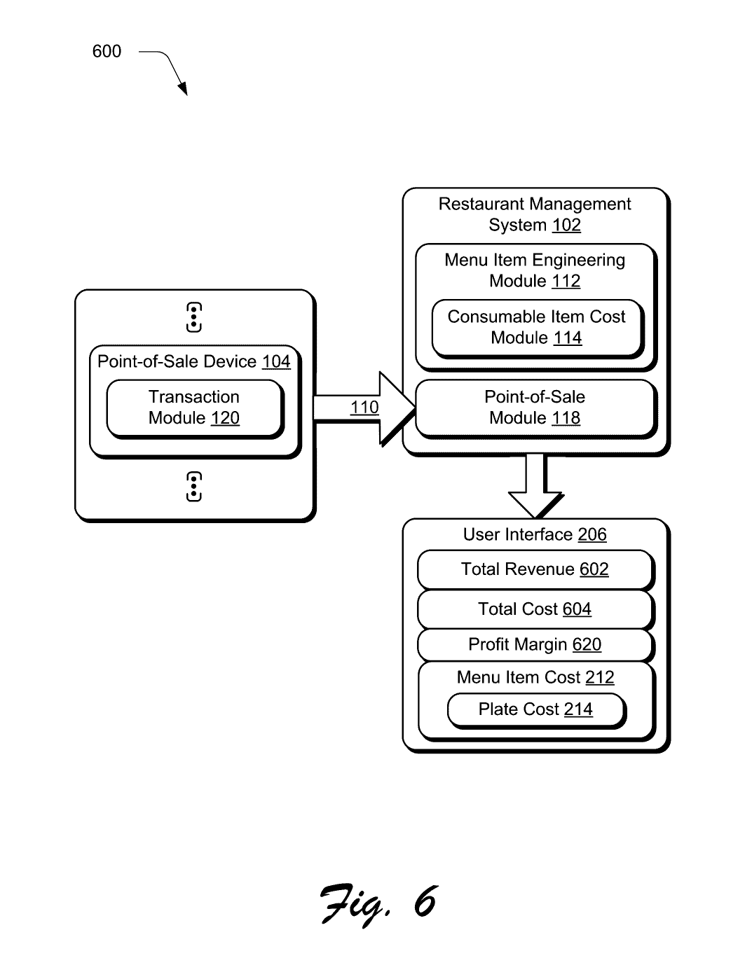

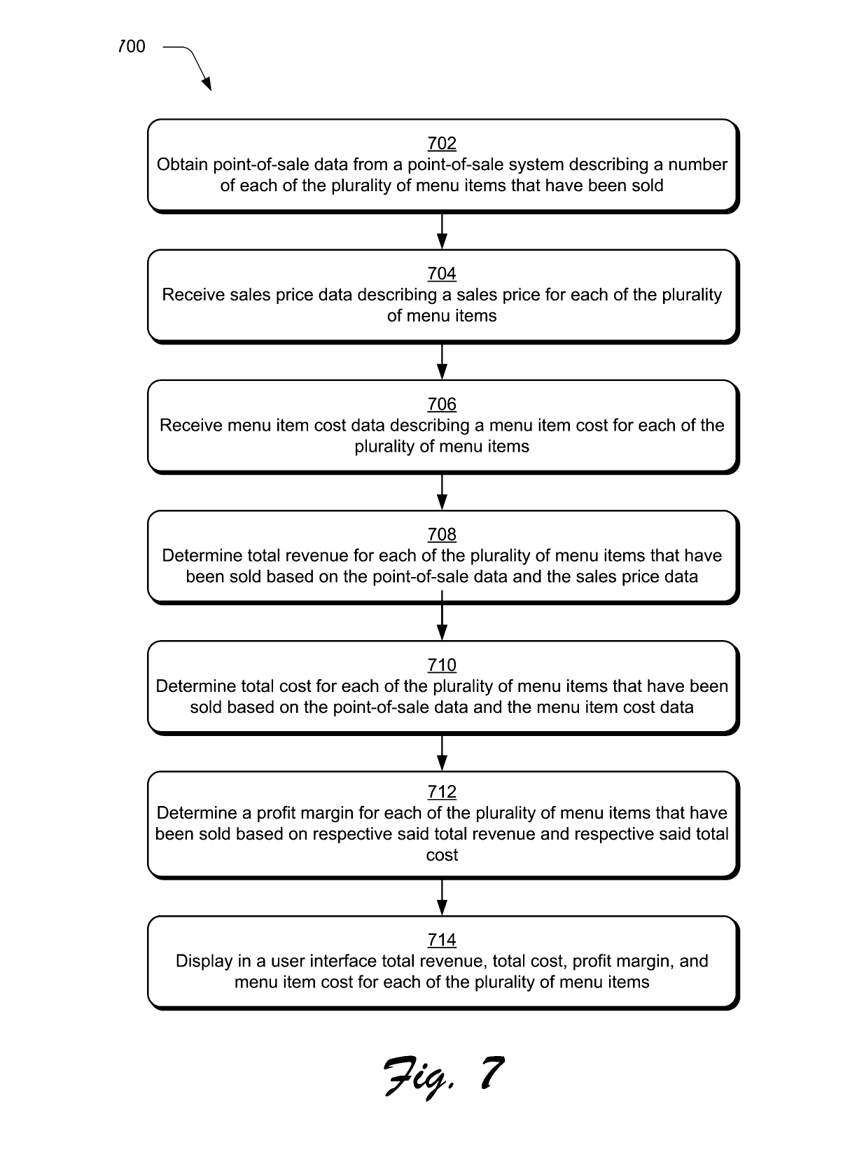

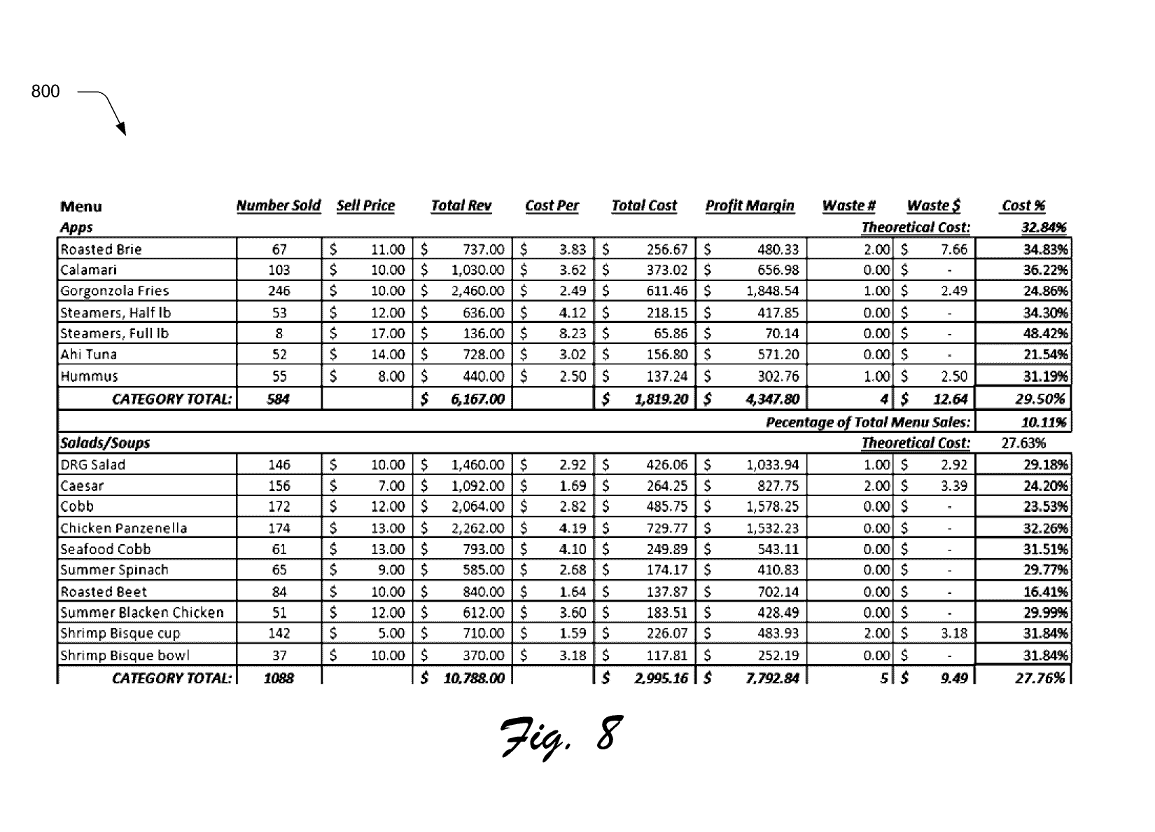

FIG. 6 depicts a system 600 in an example implementation usable to cost engineer a plurality of menu items through integration of point-of-sale data. FIG. 7 depicts a procedure 700 in an example implementation in which a menu item is cost engineered. FIGS. 8-13 depicts example user interfaces 800, 900, 1000, 1100, 1200, 1300 exposed by the system 200 of FIG. 2 that leverage point-of-sale integration.

The following discussion describes techniques that may be implemented utilizing the previously described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made interchangeably to FIGS. 6-11.

Point-of-sale data is obtained from a point-of-sale system describing a number of each of the plurality of menu items that have been sold (block 702). Sales price data is received that describes a sales price for each of the plurality of menu items (block 704). A point-of-sale module of the restaurant management system 102, for instance, may communicate with one or more point-of-sale devices 104 via a network 110. Point-of-sales data is obtained as a result of this communication that descries menu items sold and a sale price of those plurality of menu items. This data may also be used to correlate which menu items are sold together, and even which customers bought those items and demographics of those customers as further described in the discussion of recommendations in the following. This data may also include an order mode, e.g., send, don't make, to-go, walk in, pickup, and so forth.

Menu item cost data is received that describes a menu item cost for each of the plurality of menu items (block 706). The menu item cost data, for instance, may be determined for each of the plurality of menu items as described in the previous section. This may include a theoretical cost (e.g., predicted based on current costs of consumable items) or an actual “engineered” cost based on actual sales, e.g., to take into account actual waste, what was spent, and so forth.

Total revenue 602 is determined for each of the plurality of menu items that have been sold based on the point-of-sale data and the sales price data (block 708). This may be performed by adding the sale prices for particular menu items together from the point-of-sale data, multiply a number of menu items sold by a stored sales price (e.g., menu price), and so forth.

Total cost 604 is also determined for each of the plurality of menu items that have been sold based on the point-of-sale data and the menu item cost data (block 710). For example, the menu item cost 212 calculated for each of the menu items is based on the menu item cost 212 multiplied by a number of respective menu items that have been sold as indicated by the point-of-sale data. Further, a profit margin is determined for each of the plurality of menu items that have been sold based on respective said total revenue and respective said total cost (block 712).

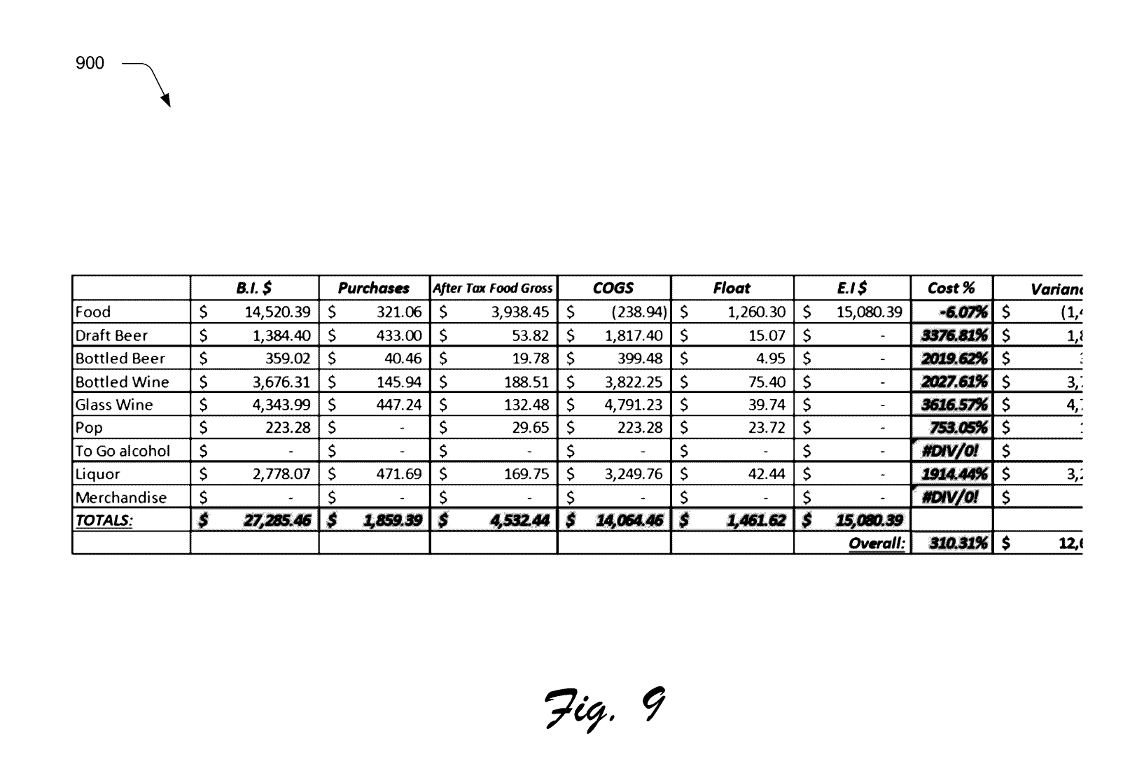

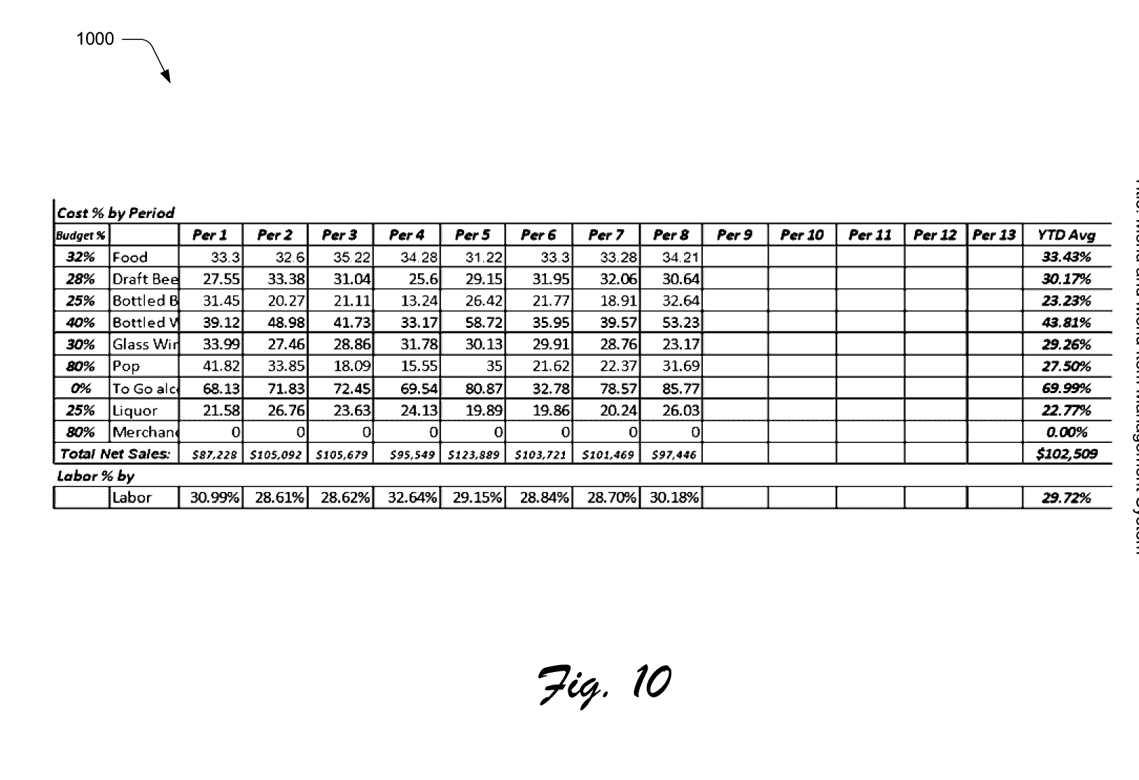

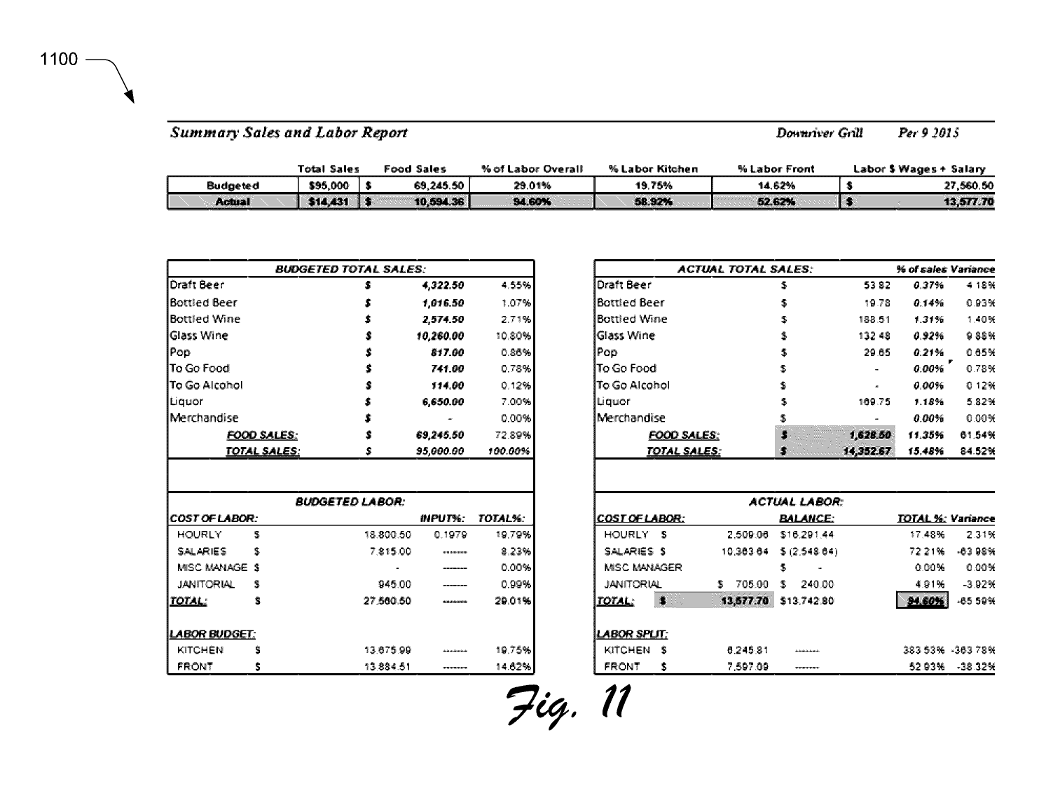

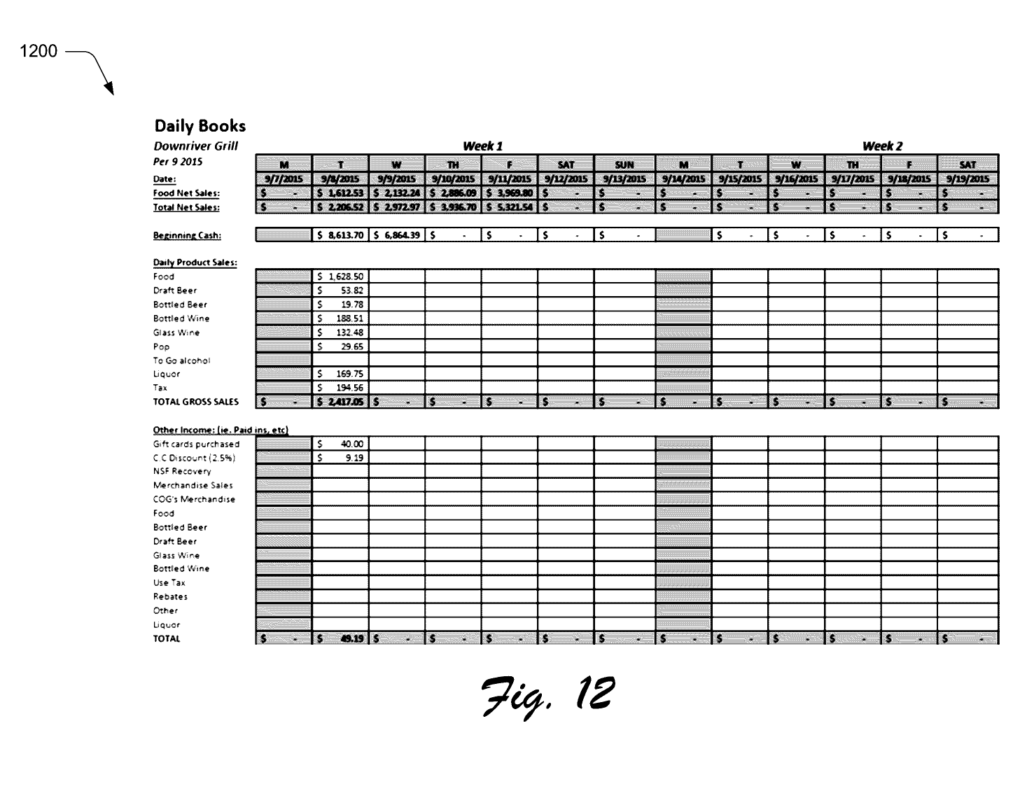

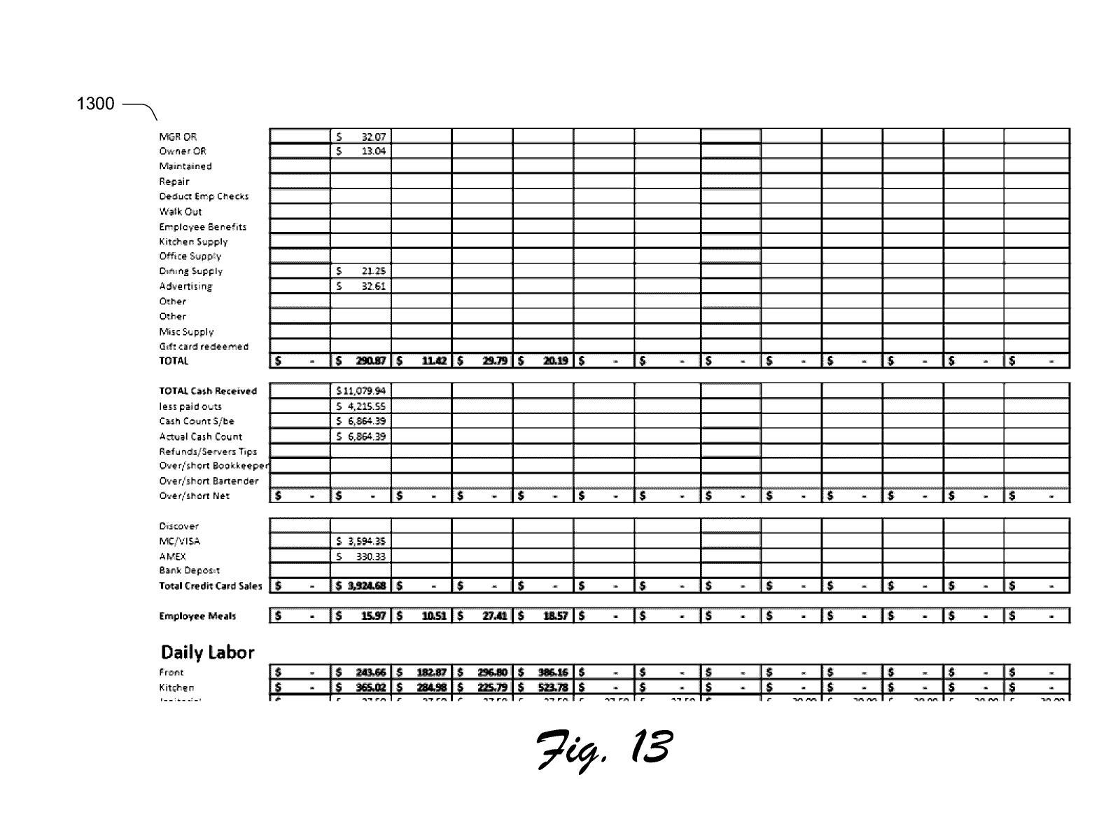

A user interface 206 then displays the total revenue 602, total cost 604, profit margin 606, and menu item cost 212 (e.g., plate cost 214) for each of the plurality of menu items (block 714). This may be performed in a variety of ways. In the user interface 800 of FIG. 8, for instance, menu items and categories are used to display a result of these determinations. In the user interface 900 of FIG. 9, similar determinations are also used to show purchases, after tax food gross, cost of goods sold, float, and so forth. In the user interface 1000 of FIG. 10, this is used to show total net sales, also by category, along with year-to-date averages. FIG. 11 includes another example of a user interface 1100 as having a summary sales and labor report plus budgeting. FIGS. 12 and 13 includes user interfaces 1200, 1300 including daily product sales and other income and expenses, by category.

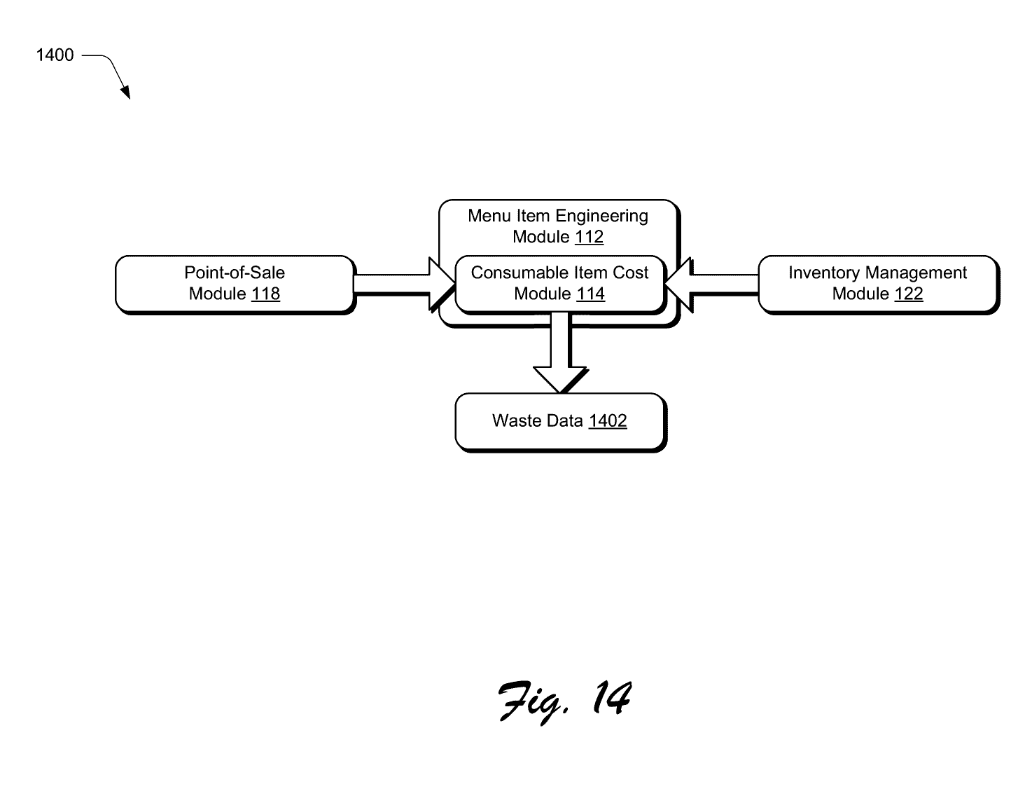

FIG. 14 depicts a system 1400 in an example implementation in which waste data is generated to track waste, which may be used to increase efficiency of cost engineering performed by the menu item engineering module 112. As described above, a point-of-sale module 118 may be used to track which menu items are sold, and consequently an amount of consumable items used as part of these sales. From ordering, performed through interaction with the consumable item cost module 114, this may be used to track actual amounts of consumable items used to support sales of a number of menu items.

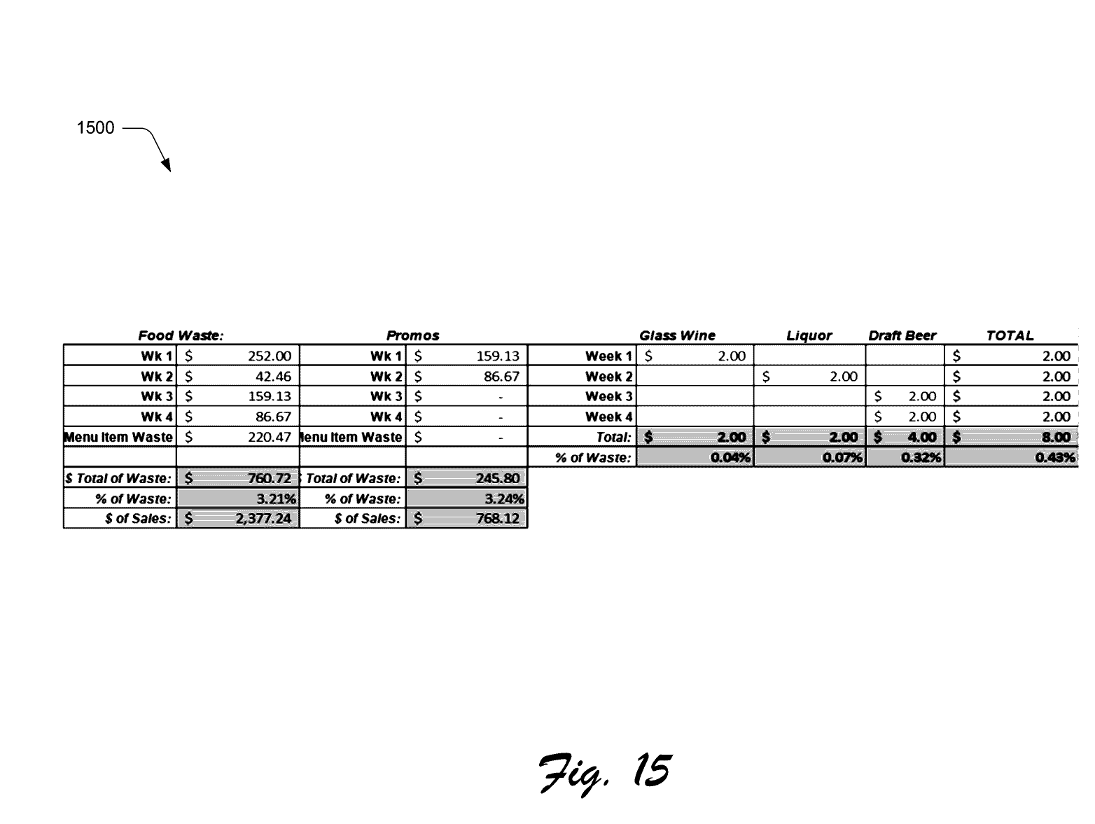

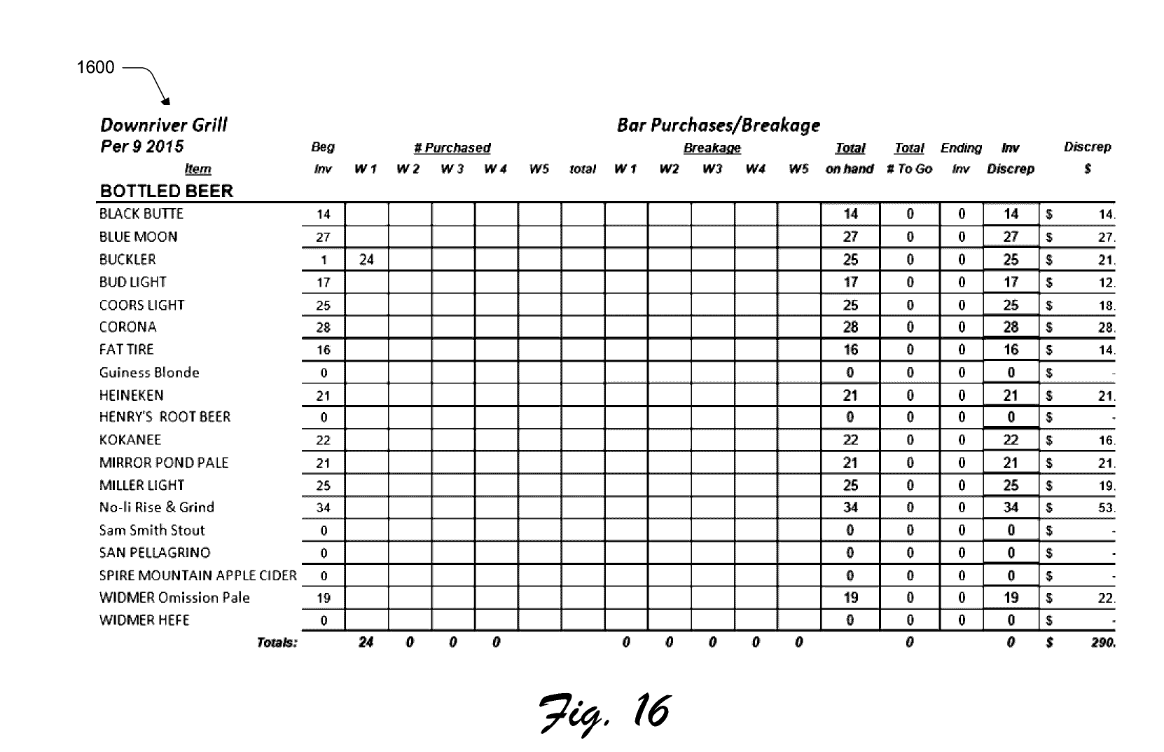

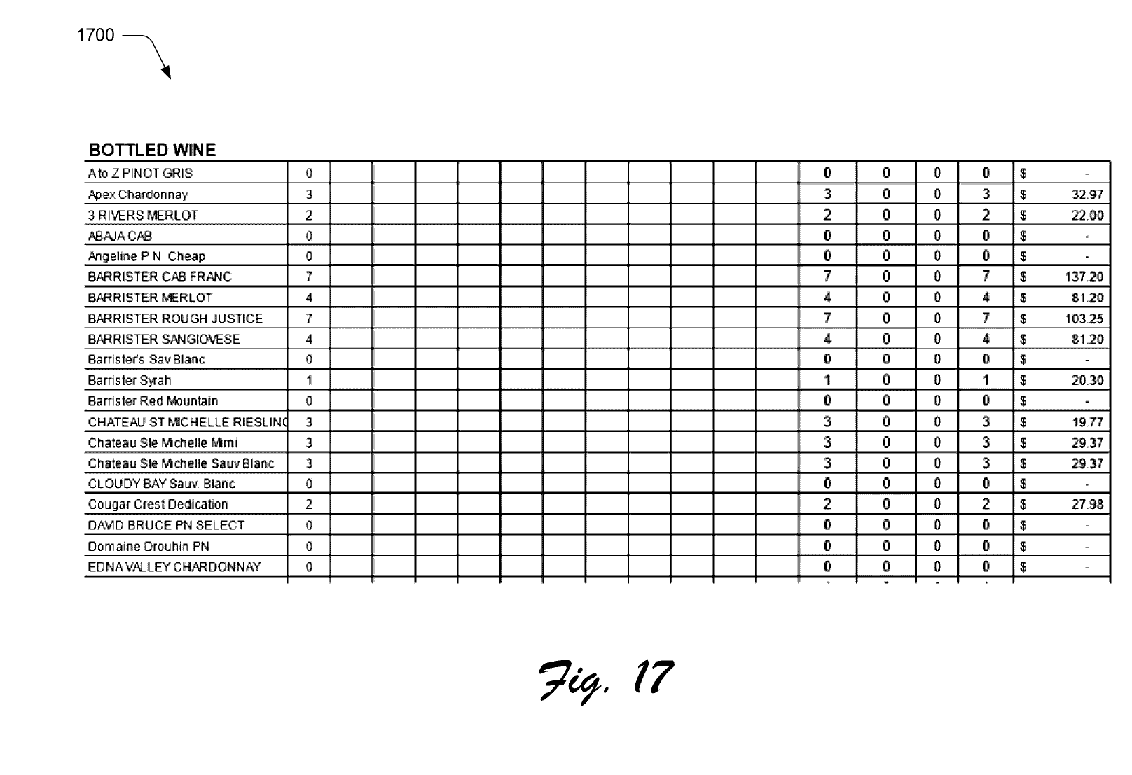

Likewise, an inventory management module 122 may be used to track consumption based on inventory used by the establishment, along with number of items sold through point-of-sale integration. Regardless of how determined, this may be used to generate waste data, which may help support increased accuracy in calculation of a menu item cost, as well as improve efficiency in ordering. FIG. 15 depicts an example user interface 1500 as outputting indications of total dollar amount and percentages of waste of food. FIGS. 16 and 17 depicts example user interfaces 1600, 1700 for beverages in which consumption is illustrated as breakage.

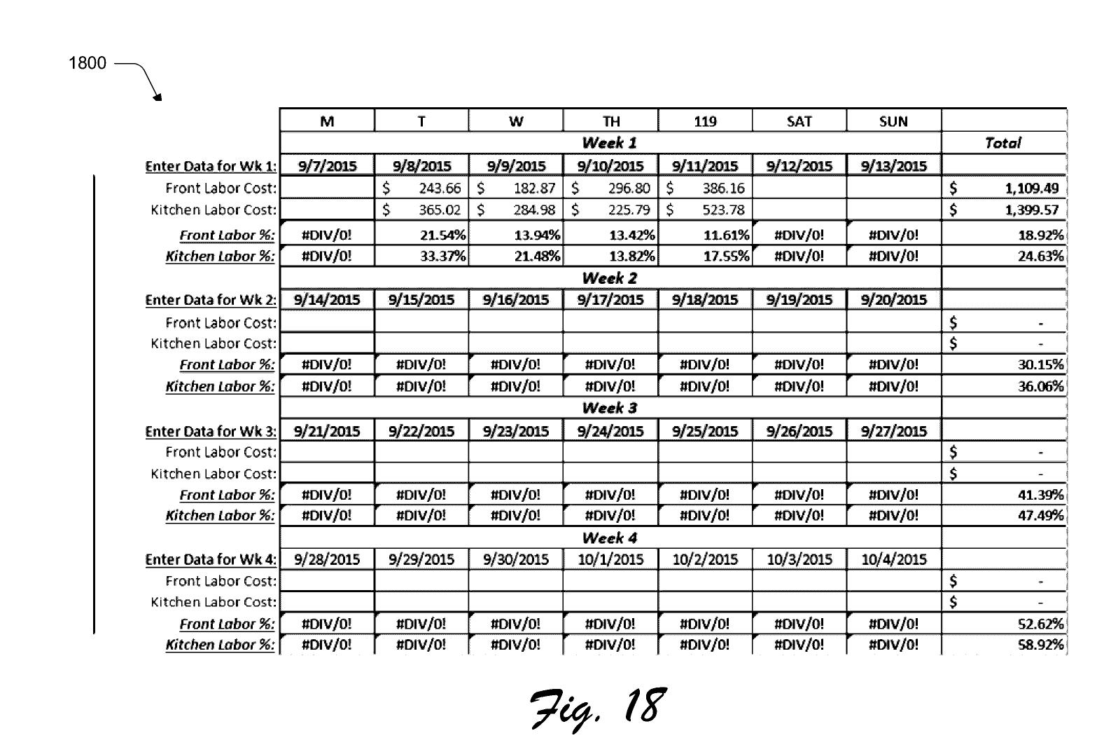

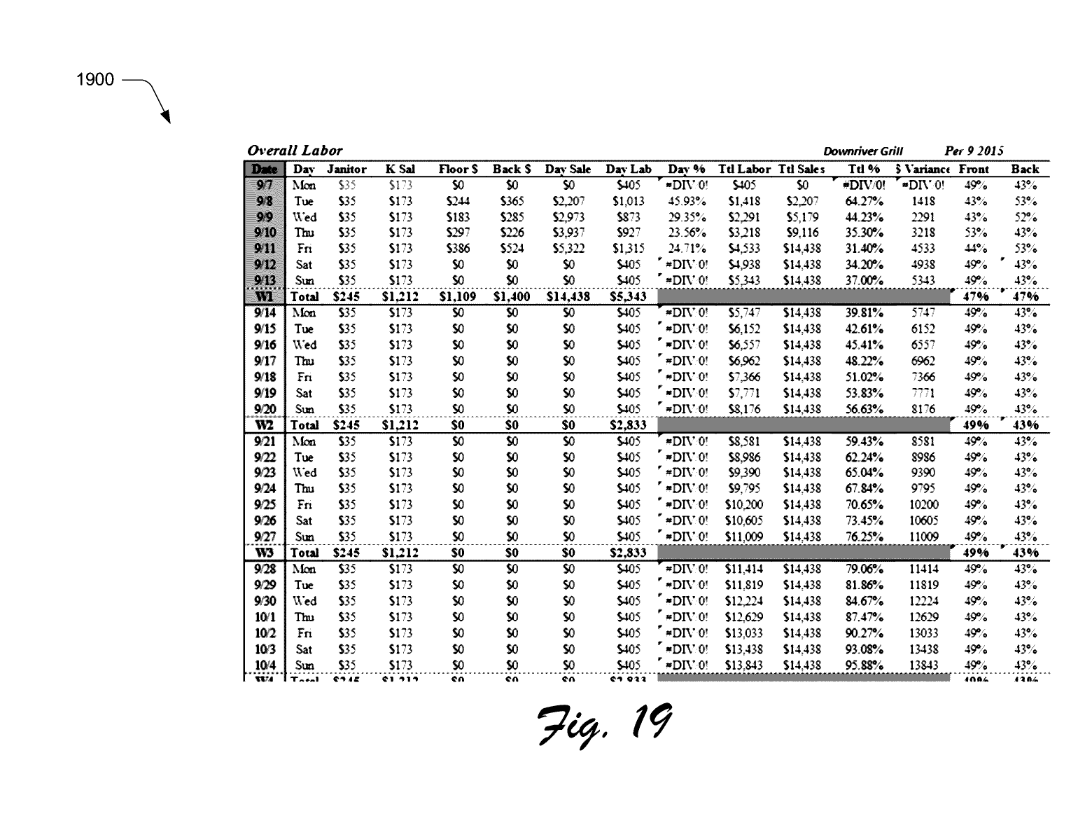

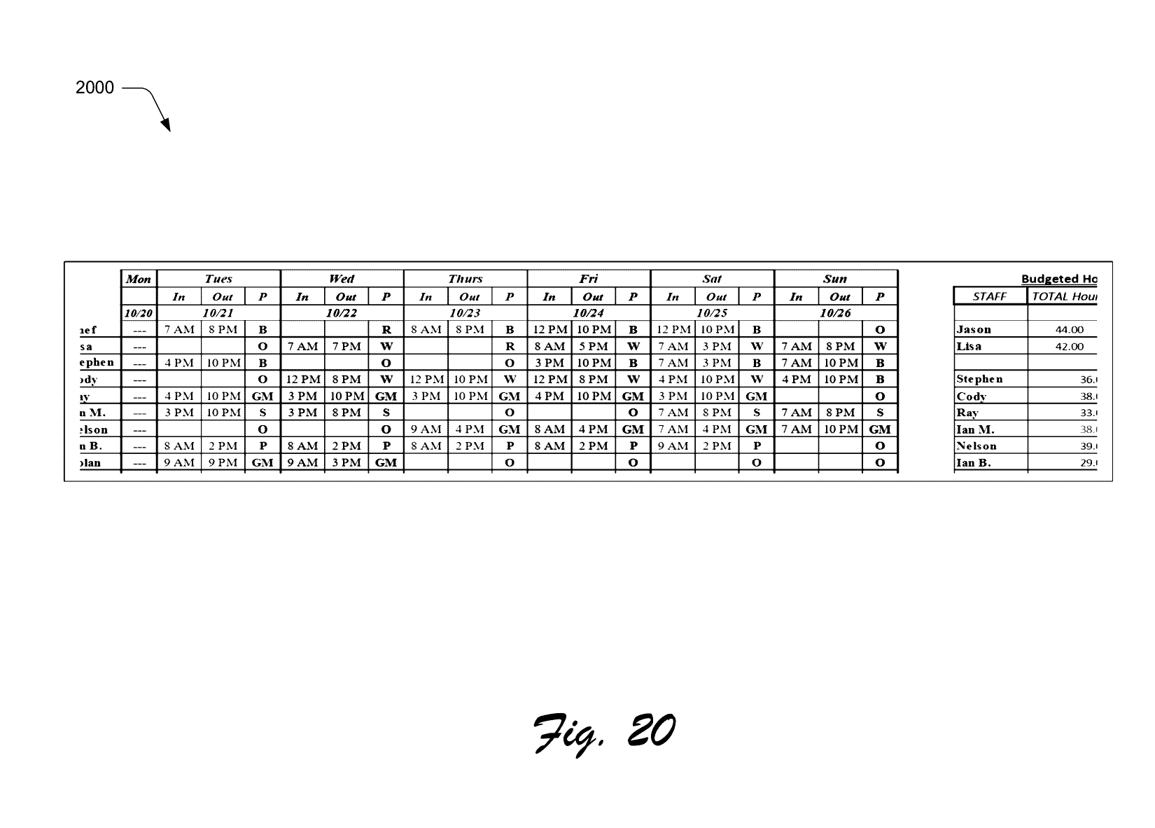

An effect of labor costs may also be exposed. The labor management module 124 of FIG. 1, for instance, may be used to compute labor costs. This may then be exposed via user interfaces so that a manager may gain detailed information about labor as it pertains to profitability. FIG. 18 includes a user interface 1800 showing a division between front labor costs (e.g., wait staff, bartenders, hosts) and kitchen labor costs. FIG. 19 depicts a user interface 1900 in which costs by day or shown for labor as it pertains to sales for a respective time period. FIG. 20 depicts a user interface 2000 usable as part of scheduling, which may be based on these labor costs and percentage of sales.

Example System and Device

FIG. 21 illustrates an example system generally at 2100 that includes an example computing device 2102 that is representative of one or more computing systems and/or devices that may implement the various techniques described herein. This is illustrated through inclusion of the menu item engineering module 112. The computing device 2102 may be, for example, a server of a service provider, a device associated with a client (e.g., a client device), an on-chip system, and/or any other suitable computing device or computing system.

The example computing device 2102 as illustrated includes a processing system 2104, one or more computer-readable media 2106, and one or more I/O interface 2108 that are communicatively coupled, one to another. Although not shown, the computing device 2102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 2104 is representative of functionality to perform one or more operations using hardware. Accordingly, the processing system 2104 is illustrated as including hardware element 2110 that may be configured as processors, functional blocks, and so forth. This may include implementation in hardware as an application specific integrated circuit or other logic device formed using one or more semiconductors. The hardware elements 2110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 2106 is illustrated as including memory/storage 2112. The memory/storage 2112 represents memory/storage capacity associated with one or more computer-readable media. The memory/storage component 2112 may include volatile media (such as random access memory (RAM)) and/or nonvolatile media (such as read only memory (ROM), Flash memory, optical disks, magnetic disks, and so forth). The memory/storage component 2112 may include fixed media (e.g., RAM, ROM, a fixed hard drive, and so on) as well as removable media (e.g., Flash memory, a removable hard drive, an optical disc, and so forth). The computer-readable media 2106 may be configured in a variety of other ways as further described below.

Input/output interface(s) 2108 are representative of functionality to allow a user to enter commands and information to computing device 2102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 2102. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 2102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 2110 and computer-readable media 2106 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 2110. The computing device 2102 may be configured to implement particular instructions and/or functions corresponding to the software and/or hardware modules. Accordingly, implementation of a module that is executable by the computing device 2102 as software may be achieved at least partially in hardware, e.g., through use of computer-readable storage media and/or hardware elements 2110 of the processing system 2104. The instructions and/or functions may be executable/operable by one or more articles of manufacture (for example, one or more computing devices 2102 and/or processing systems 2104) to implement techniques, modules, and examples described herein.

The techniques described herein may be supported by various configurations of the computing device 2102 and are not limited to the specific examples of the techniques described herein. This functionality may also be implemented all or in part through use of a distributed system, such as over a “cloud” 2114 via a platform 2116 as described below.

The cloud 2114 includes and/or is representative of a platform 2116 for resources 2118. The platform 2116 abstracts underlying functionality of hardware (e.g., servers) and software resources of the cloud 2114. The resources 2118 may include applications and/or data that can be utilized while computer processing is executed on servers that are remote from the computing device 2102. Resources 2118 can also include services provided over the Internet and/or through a subscriber network, such as a cellular or Wi-Fi network.

The platform 2116 may abstract resources and functions to connect the computing device 2102 with other computing devices. The platform 2116 may also serve to abstract scaling of resources to provide a corresponding level of scale to encountered demand for the resources 2118 that are implemented via the platform 2116. Accordingly, in an interconnected device embodiment, implementation of functionality described herein may be distributed throughout the system 2100. For example, the functionality may be implemented in part on the computing device 2102 as well as via the platform 2116 that abstracts the functionality of the cloud 2114.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment, a method of cost engineering a menu item, the method implemented by at least one computing device, the method comprising:
collecting, by the at least one computing device, cost data describing costs of consumable items;
receiving, by the at least one computing device, user inputs specifying selection of representations of consumable items in a user interface for inclusion as part of a menu item;
receiving, by the at least one computing device, inputs that specify a menu price for the menu item;
determining, by the at least one computing device, a menu item cost for the menu item based at least in part on the cost data and the user inputs and an item cost percentage based on the menu price and the menu item cost; and
displaying, by the at least one computing device, the menu item cost and the item cost percentage in the user interface.

2. The method as described in claim 1, wherein the consumable items include food, drink, or disposable items used as part of preparation or consumption of food or drink.

3. The method as described in claim 1, wherein the cost data is collected via a network from a consumables supply service, the cost data describing the cost of the consumable items from the consumables supply service.

4. The method as described in claim 1, further comprising updating the cost data describing costs of consumable items in real time automatically and without user intervention and in response to the updating repeating the determining and the displaying using the updated data.

5. The method as described in claim 1, wherein the representations of consumable items are displayed in units of measure as used in single one of the menu item and further comprising converting the costs of the consumable items form a unit of measure used to order the consumable items to the units of measure as used in a single one of the menu item as part of the determining to arrive at the menu item cost and the item cost percentage for the menu item.

6. The method as described in claim 1, wherein the determining of the menu item cost for the menu item based at least in part on the cost data and the user inputs or the item cost percentage based on the menu price and the menu item cost is based at least in part on waste data describing an amount of respective said consumable items that are considered waste.

7. The method as described in claim 6, wherein the waste data is based at least in part on data obtained from a point-of-sale system.

8. The method as described in claim 6, wherein the waste data is based at least in part on inventory.

9. The method as described in claim 6, wherein the waste data is based at least in part on ordering of the plurality of consumable items from a consumables supply service.

10. The method as described in claim 1, further comprising:
receiving a user input via the user interface assigning a particular one of a plurality of menu categories to the menu item;
determining a menu category menu item cost for the particular menu category based on a plurality of said menu items assigned to the particular menu category and a menu category food cost for the particular menu category based on menu prices of the plurality of said menu items assigned to the particular menu category and the menu category menu item cost for the particular menu category; and
displaying, by the at least one computing device, the menu category menu item cost and the menu category food cost in the user interface.

11. In a digital medium environment, a method of cost engineering a menu having a plurality of menu items, the method implemented by at least one computing device, the method comprising:
obtaining, by the at least one computing device, point-of-sale data from a point-of-sale system describing a number of each of the plurality of menu items that have been sold;
receiving, by the at least one computing device, sales price data describing a sales price for each of the plurality of menu items;
receiving, by the at least one computing device, menu item cost data describing a menu item cost for each of the plurality of menu items;
determining, by the at least one computing device, total revenue for each of the plurality of menu items that have been sold based on the point-of-sale data and the sales price data;
determining, by the at least one computing device, total cost for each of the plurality of menu items that have been sold based on the point-of-sale data and the menu item cost data; and
determining, by the at least one computing device, a profit margin for each of the plurality of menu items that have been sold based on respective said total revenue and respective said total cost;
displaying, by the at least one computing device, in a user interface total revenue, total cost, profit margin, and menu item cost for each of the plurality of menu items.

12. The method as described in claim 11, wherein the sales price data is received from the point-of-sale system or from a menu price for a respective said men item as listed on a menu.

13. The method as described in claim 11, further comprising generating the menu item cost data by:
collecting, by the at least one computing device, cost data describing costs of consumable items;
receiving, by the at least one computing device, user inputs specifying selection of representations of consumable items in the user interface for inclusion as part of a respective menu item of the plurality of menu items; and
determining, by the at least one computing device, the menu item cost as part of the menu item cost data for the respective menu item based at least in part on the cost data and the user inputs.

14. The method as described in claim 13, further comprising:
receiving a user input via the user interface assigning a particular one of a plurality of menu categories to the respective menu item;
determining a menu category menu item cost for the particular menu category based on a plurality of said menu items assigned to the particular menu category and a menu category food cost for the particular menu category based on menu prices of the plurality of said menu items assigned to the particular menu category and the menu category menu item cost for the particular menu category; and
displaying, by the at least one computing device, the menu category menu item cost and the menu category food cost in the user interface.

15. In a digital medium environment, a restaurant management system to cost engineer a menu item, the restaurant management comprising:
a consumable item cost module implemented at least partially in hardware to collect cost data describing costs of consumable items;
a user interface manager module implemented at least partially in hardware to receiving, by the at least one computing device, user inputs specifying selection of representations of consumable items in a user interface for inclusion as part of a menu item;
a cost determination module implemented at least partially in hardware to:
receive inputs that specify a menu price for the menu item;
determine a menu item cost for the menu item based at least in part on the cost data and the user inputs and an item cost percentage based on the menu price and the menu item cost; and
display the menu item cost and the item cost percentage in the user interface.

16. The system as described in claim 15, wherein the consumable items include food, drink, or disposable items used as part of preparation or consumption of food or drink.

17. The system as described in claim 15, wherein the cost data is collected via a network from a consumables supply service, the cost data describing the cost of the consumable items from the consumables supply service.

18. The system as described in claim 15, wherein the consumable item cost module is configured to update the cost data describing costs of consumable items in real time automatically and without user intervention and in response to the updating repeating the determining and the displaying using the updated data.

19. The system as described in claim 15, wherein the representations of consumable items are displayed in units of measure as used in single one of the menu item and further comprising converting the costs of the consumable items form a unit of measure used to order the consumable items to the units of measure as used in a single one of the menu item as part of the determining to arrive at the menu item cost and the item cost percentage for the menu item.

20. The system as described in claim 15, wherein the cost determination module is further configured to:
receive a user input via the user interface assigning a particular one of a plurality of menu categories to the menu item;
determine a menu category menu item cost for the particular menu category based on a plurality of said menu items assigned to the particular menu category and a menu category food cost for the particular menu category based on menu prices of the plurality of said menu items assigned to the particular menu category and the menu category menu item cost for the particular menu category; and
display, by the at least one computing device, the menu category menu item cost and the menu category food cost in the user interface.
